(19) United States
(12) Patent Application Publication
(10) Pub. No.: US 2016/0292734 A1
(43) Pub. Date: Oct. 6, 2016

(54) Systems and methods for advertising into online conversation context based on real time conversation content

(71) Applicant: Yiyu Jia, Bedford, MA (US)

(72) Inventor: Yiyu Jia, Bedford, MA (US)

(21) Appl. No.: 15/091,618

(22) Filed: Apr. 6, 2016

Related U.S. Application Data
(60) Provisional application No. 62/143,509, filed on Apr. 6, 2015.

(51) Int. Cl. G06Q 30/02; G06N 99/00

(52) U.S. Cl. CPC G06Q 30/0256; G06Q 30/0255; G06Q 30/0277; G06N 99/005

(57) ABSTRACT

The subject invention provides a method, business process and computer program product that can be applied into any type of instant messaging apps for displaying advertisement (ad). The proposed method and system can capture and process the content of live conversation occurred within the instant messenger. Based on the live conversation context, the system selects the ad content and injects it into the live conversation in such a way that all users involved in the chatting group/room can see it. The whole system includes sub systems for ad advertiser (or advertisers agent) and ad publisher subscription. Other key parts of this system include a central database system and a crowdsourcing based, machine learning enabled ad recommendation engine. This invention also includes a novel business process or business model based on the above mentioned system. It releases ad content through publishers online chat account. It allows individual person to act as ad publishers with almost zero cost. Reciprocally, the ad publishers help improve the ad recommender engine for more precise ad delivery through crowdsourcing. This invention essentially enables an innovative forms of Mesh Economy.

This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claim.

### CROSS-REFERENCE TO RELATED APPLICATIONS

This application claims the benefit of a provisional patent application with the same title, No 62/143509, filed on Apr. 06, 2015 The content of the aforementioned application, including any intervening amendments thereto, is incorporated herein by reference.

### BACKGROUND OF THE INVENTION

The subject invention is an innovation in the field of online advertising (or Internet advertising), which is a form of marketing and advertising where the Internet is used as the media to deliver promotional marketing messages to consumers. It includes email marketing, display advertising, search engine marketing (SEM), social media marketing, and mobile advertising etc. Like other advertising media, online advertising involves an ecosystem with two, major players: advertiser and ad publisher.

The advertiser owns and provides the ads to be displayed, and the ad publisher integrates and publishes ads into some online content. Traditional online ad publishers include online search engine providers, the owner of social network sites, the owner of regular web sites, the vendor of mobile apps, etc.
The media of advertising industry is rapidly evolving in the past three decades. From the traditional advertising media such as newspapers, TV, and radio, to recently thriving Internet advertising via email, web search engine, online streaming video, the market is starting another big leap—social network advertising and mobile advertising on smart devices. First of all, Internet advertising has a shift to social network advertising. Social network advertising, also called social media targeting, is a form of online advertising that focuses on social networking sites. One of the major benefits of advertising on a social networking site (e. g. such as Linkedin™, Facebook™, Twitter™, Myspace™, Friendster™, Bebo™, Orkut™, etc.) is that advertisers can take advantage of the user's demographic information and target their ads appropriately. On the other hand, mobile ads on smartphones can appear either through the Web browsers, or within mobile apps. Among many forms of online advertising schemes adapt to the mobile platform, social network advertising is the one that takes advantage of unique features of mobile devices. It gains more attention in the mobile settings as people tend to hang around with their social network friends through the mobile apps in smartphones. There are also vendors who are specialized developing social network apps mainly on smart mobile devices. The examples of such mobile apps include WeChat™, WhatsApp™, LINE™, etc.

The targeting approach of advertising is also evolving. Ads are not supposed to send to everyone. To make it effective, the advertiser always intends to send the ads to a targeted population who are potentially interested in the product or service in the ad. Online advertising, in particular, has been walked its way from traditional banner advertising to more effective targeted advertising such as behavioral targeting, which takes into account of user specific traits such as geographic locations, demographics, product purchase history, etc. It works by collecting the Internet user's behavioral features via anonymously monitoring and tracking the content read and sites visited by a user or IP when that user surfs on the Internet. A further refinement to behavioral targeting is predictive behavioral targeting, where machine learning algorithms overlay behavioral patterns with sampled data to create data-rich predicted profiles for every user. The major disadvantage of behavioral targeting are three-fold. First, this targeting approach requires the acquisitior of user's historic behavior data, which poses technical difficulty. Second, this approach entails a lag period for the user's interest. With the assumption that the user's future behavior is highly correlated with his/her past behavior, it does not consider the fact that the user's interest may have shifted many times from his/her past online behavior. Third, the user's privacy is a big concern. Many studies show that this ad targeting approach has negative impact on user experience in terms of privacy leakage.

Finally, the ad publisher is evolving. Advertisers pay ad publishers for publishing ads at appropriate venues where the corresponding ad targets the right group of people. The online ad publishers mainly take advantage of machine based, automatic behavioral targeting. These publishers are paid via innovative forms of payment mode such as pay per click, pay per call, or social network friends network sharing [1]. With such advertising systems, the advertiser makes the payment to the publisher on any click or phone call generated by people that browse their websites. The online ad publishers, also search engine providers such as Google, Yahoo, and Microsoft, adopt pay per click strategy with success. Typically only the vendor of the corresponding social network, software is able to serve as the ad publisher to insert ads within the app. We argue that this type of ad publisher monopoly should be broken in order to have more diverse, versatile, and potentially more effective advertising strategy.

The advertisers always seek more effective channels to distribute theirs ads. Of these channels, online advertising is widely used, across virtually all industry sectors and is steadily growing its share. In 2011, online advertising revenues in the United States surpassed those of cable television and nearly exceeded those of broadcast television [1]. Paralleling to the fact that smartphone starts to become mainstream and highly engaged mobile devices in many people's daily life, the mobile advertising spending is growing its share significantly. According to the leading industry research [2], advertisers will spend $64.25 billion worldwide on mobile in 2015, which is an increase of nearly 60% over 2014 By year 2018, this figure is expected to reach $158.55 billion, when the mobile advertising will account for 22.3% of the total advertising spending. Within the mobile app world, the use of instant messaging mobile apps is growing, and billions of people use alike mobile apps such as WeChat™, WhatsApp™, LINE™ etc. every day. Considering the advertising spending trend and huge market potential of instant messaging mobile apps, it is very promising to propose innovative forms of advertising in this sector.

There are several instant messaging programs, but only a few programs worldwide that are largely used. With software of several megabytes, users can exchange with each other textual messages, send emoticons, attach pictures and even talk to each other using Voice over Internet Protocol (VoIP) technologies. This invention mainly targets developing a system to deliver precise ad item to instant messaging users and, based on the system, developing a novel business model that applies concept of mesh economy [4].

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

With the development of above mentioned three areas, including the media of advertising, the ad targeting approach, and ad publisher, the subject invention provides a method, business process and computer program product that can be applied into any type of instant messaging apps for displaying advertisement (ad). We describe the invention details as follows.

First, the ad is targeting to the real time conversation. When the instant messenger users have a message based conversation in a chat room/group, the system conducts data mining to extract the keywords and topic words from the live conversations. All the captured conversation messages within a time window are either preprocessed on the ad publisher's terminal, or sent to the backend Big Data processing platform. Preprocessing the live conversation content on client side not only reduce server's computing burden, but also reduce user's concern about privacy leakage. With the keywords or topic words as the input to the ad recommendation engine at the backend, the matching ads will be generated from it as the recommendations to display in the live conversation in near real time.

Second, the system provides three modes for the ad publishing into the real time conversation with in the instant messaging mobile apps These three modes include: (1) the ad is released into real time conversation context automatically; (2) the ad has to get approved by the publisher before released into the real time conversion; (3) the publisher searches the ad database with topic words and/or keywords and find matching ad and release it. The individual instant messenger user acts as the ad publisher to control one of these three modes. In all three modes, the keywords and topic words can be adjusted by the ad publisher and submitted back to server application hosted in the Cloud.

Third, for all of these three modes, the system supplies a User Interface (UI) to monitor recent released ad logs, and allows the publisher to adjust the score about how precise the ad recommendation was. For instance, the score ranges from 1 to 10. The backend recommendation engine can choose different machine learning models including topic analysis, semantic analysis, and keywords analysis for specific type of advertisement and chat group. Furthermore, recommendation engine can update machine learning model in near real time based on feedback. This feedback channel is claimed as benefit as applying crowdsourcing model into text analysis algorithm. The ad publisher can not only score the ad recommendation accuracy but also adjust the ad associated topics and keywords in the backend ad—keywords database. Furthermore, publisher can input topic and/or keywords to search relevant advertisement that can be released into current conversation context.

Fourth, the backend Big Data platform employs sentiment analysis and opinion mining for processing data and training model. Different from normal opinion mining application, where one opinion from a single opinion holder is usually not sufficient for action, this invention a real time opinion mining, which focus more on a single opinion holder. This invention applies the concept of crowdsourcing to achieve precise ad delivery and continuously machine learning model training [5]. Current conversation context and advertisement item topic and keywords info will be sent back to backend big data processing system to optimize machine learning model. Therefore, the whole system can recommend more and more precise ad item for target conversation. Furthermore, by using topic trend analysis techniques, this invention can also predict interesting ad contents for a particular chat group. Most important, this invention uses real time conversation content for recommending ad items. Different from existing ad recommendations engines, which use user behavior data and Internet surfing history, this invention deliver precisely target ad items to users in near real time. Meanwhile, those existing traditional ad recommendation engines obviously has latency in delivering ad item to users, who may lost interests or mood on that product already.

Fifth, the ad server has GUI for small or medium business owner, in-house advertising agent and advertise agents [6]. Currently, there are many third party online advertising platforms, which faces business owner, or in-house agent. This invention has function and GUI for not only business owner and in-house agent, but also all localized advertising agent, who has tight connection with those local business owners. This system also supplies these local small ad agent company a zero cost business to be started. Therefore, more small and medium business owners can put their advertisement in the system.

Sixth, this invention also makes a novel business model be possible. With this invention, anyone who owns an online chat account can register to be ad publisher and earn certain income. This invention capture and process real tin e online conversation content through publishers online chat account. After processing the real time content, ad recommend engine recommend ad items and the system inject ad items into real time conversation context through publishers online chat account. Or, publishers can manually search in the system based on their understanding about the real time conversation content.

Seventh, this invention also develops a system that allows ad content to be host on distributed different domain servers. For example, ad content can be hosted on advertiser's own Web portal. This is important as it could be useful in case instant messenger vendor maliciously block domain name of centralized hosted ad content servers, which share same few domain names.

To summarize, the subject invention is innovative from following aspects. First takes a novel targeting approach. This approach does not collect the user's online behavioral data therefore is technically less complex to implement in terms of data acquisition. It captures and analyzes the real time, conversation context that is happening at the very moment. Therefore, this system can deliver precise advertisement content to users at the moment when they have the greatest interest on the topic. It does not track the user's online behavior and therefore free from ethical issue of violating the user's privacy. Second, it integrates advanced analytics such as text mining, sentiment analysis to extract ads from the database, and utilizes the crowdsourcing technique to optimize the recombination engine. Third, it creates a novel business model where anyone who owns an online messaging account can register to be ad publisher and earn an income. To walk around possible instant messenger vendor's against a novel way, which hosts ad content in distributed ad content server having different domain names, is introduced as well.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram illustrating one example of a system for advertising into Instant Messenger chatting context, according to one embodiment.

FIG. 2 depicts one example of a graphical user interface running on a computing device capable of running an instant messaging client and/or web browser, according to one embodiment.

FIG. 3 is a block diagram illustrating one example of overall flow chart about how the chat context is processed and ad is recommended, according to one embodiment.

FIG. 4 is a block diagram illustrating one example of how an ad is released into chat context and how a publisher can contribute to improve backend recommend engine, according to one embodiment.

FIG. 5 is a sequence diagram illustrating one example of how the ad content can be distributed to any domain server.

FIG. 6 is use case diagrams illustrating one example of low the business model included in this Invention bring publishers, users, and advertisers together and do advertising in a shared economy way.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order to not obscure the description of the invention with unnecessary detail.

### DEFINITIONS

Some of the terms used in this description are defined below (in alphabetical order) for easy reference. These terms are not rigidly restricted to these definitions. A term may be further defined by the term's use in other sections of this description.

“Ad” (e.g. ad, and/or message) means a paid announcement, as of goods or services for sale, preferably on a network such as the internet. An ad may also be referred to as an item and/or a message.

“Ad click-through rate” (e.g. click-through rate) means a measurement of ad clicks per a period of time.

“Ad server” is a server that is configured for serving one or more ads to user devices. An ad server is preferably controlled by organization who implemented this invention. A server is defined below.

“Advertiser” (e.g. messenger and/or messaging customer, etc.) means an entity that is in the business of marketing a product and/or a service to users. An advertiser may include, without limitation, a seller and/or a third-party agent for the seller. An advertiser may also be referred to as a messenger and/or a messaging customer. Advertising may also be referred to as messaging.

“Advertising” means marketing a product and/or service to one or more pate consumers by using an ad. One example of advertising is publishing a sponsored search ad on a website.

“Application server” is a server that is configured for running one or more devices loaded on the application server.

“Click” (e.g. ad click) means a selection of an ad impression by using a selection device such as, for example, a computer mouse or a touch-sensitive display.

“Client” means the client part of a client-server architecture. A client is typically a user device and/or an application that runs on a user device. A client typically relies on a server to perform some operations. For example, an email client is an application that enables a user to send and receive email via an email server. In this example, the computer running such an email client may also be referred to as a client.

“Conversion” (e.g. ad conversion) means two or more user chat via Instant Messenger. “Database” (e.g. database system, etc.) means a collection of data organized in such a way that a computer program may quickly select desired pieces of the data. A database is an electronic filing system. In some instances, the term “database” is used as shorthand for a “database management system”. A database may be implemented as any type of data storage structure capable of providing for the retrieval and storage of a variety of data types. For instance, a database may include one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc. A database may be implemented as SQL database or NoSQL database, NewSQL and other Big Data platform.

“Device” means hardware, software or a combination thereof. A device may sometimes be referred to as an apparatus. Examples of a device include, without limitation, a software application such as android mobile application, web browser plugin, Whatsup™, Line™ or WeChat™ etc.; or hardware such as a mobile phone, a laptop computer, a server, a display: or a computer mouse and/or a hard disk.

“Impression” (e.g. ad impression) means a delivery of an ad to a user device for viewing by a user.

“Item” means an ad, which is defined above.

“Message” means an ad, which is defined above.

“Messaging” means advertising, which is defined above.

“Network” means a connection, between any two or more computers, that permits the transmission of data. A network may be any combination of networks including, without limitation, the internet, a local area network, a wide area network, a wireless network, and/or a cellular network.

“Publisher” means an entity that publishes, on a network, ad item into an instant messenger's real time conversation context or a web page having content and/or ads, etc.

“Server” means a software application that, provides services to other computer programs (and their users) on the same computer or on another computer or computers. A server may also refer to the physical computer that has been set aside to run specific server application. For example, when the software Apache HTTP Server is used as the web server for a company's website, the computer running Apache may also be called the web server. Server applications may be divided among server computers over an extreme range, depending upon the workload.

“Software” means a computer program that is written in a programming language that may be used by one of ordinary skill in the art. The programming language chosen should be compatible with the computer on which the software application is to be executed and, in particular, with the operating system of that computer. Examples of suitable programming languages include, without limitation, Object Pascal, C, C++ and/or Java. Further, the functions of some embodiments, when described as a series of steps for a method, could be implemented as a series of software instructions for being operated by a processor such that the embodiments could be implemented as software, hardware, or a combination thereof. Computer-readable media are discussed in more detail in a separate section below.

“System” means a device or multiple coupled devices. A device is defined above.

“User” (e.g. consumer, etc.) means an operator of a user device. A user is typically a person who seeks to acquire a product and/or service. For example, a user may be a woman who is talking about shopping for a new cell phone to replace her current cell phone. The term “user” may also refer to a user device, depending on the context.

“User device” (e.g. computer, user computer client and/or server, etc.) means a single computer or a network of interacting computers. A user device is a computer that a user may use to communicate with other devices over a network, such as the internet. A user device is a combination of a hardware system, a software operating system, and perhaps one or more software application programs. Examples of a user device include, without limitation, a laptop computer, a palmtop computer, a smart phone, a cell phone, a mobile phone, an IBM-type personal computer (PC) having an operating system such as, Android™, Windows Phone ™, iOS™, Microsoft Windows™, an Apple™ computer having an operating system such as MAC-OS, hardware having a JAVA-OS operating system, and/or a Sun Microsystems™ workstation having a UNIX operating system. “Web browser” means a software program that may display text or graphics or both, from web pages on websites. Examples of a web browser include, without limitation, Mozilla Firefox™, Microsoft Internet Explorer™, Chrome™, and Safari™.

“Web page” means documents written in a mark-up language including, without limitation, HTML (hypertext mark-up language), VRML (virtual reality modeling language), HTML5, JSON, XML (extensible mark-up language), and/or other related computer languages. A web page may also refer to a collection of such documents reachable through one specific internet address and/or through one specific website. A web page may also refer to any document obtainable through a particular URL (uniform resource locator).

“Web porter” (e.g. public portal) means a website or service that offers a broad array of resources and services such as, for example, email, forums, search engines, and online shopping malls. The first web portals were online services, such as AOL, that provided access to the web. However, now, most of the traditional search engines (e.g. Yahoo™) have transformed themselves into web portals to attract and keep a larger audience.

“Web server” is a server configured for serving at least one web page to a web browser. An example of a web server is a Yahoo!™ web server. A server is defined above.

“Website” means one or more web pages. A website preferably includes a plurality of web pages virtually connected by links or URL addresses to form a coherent group.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

Introduction to this Invention

Users of instant messaging clients have become accustomed to asking for information on the same display surface as is their instant messaging graphical user interface. For example, a user may ask for information about one brand of product. The other user in the same conversation context may help him/her by presenting a text, graphic, audio, video and/or URL linkage. These helps are all free. This invention is a system that allow any Instant Messenger user to be able to earn money by presenting precisely ad to his/her chatting partner. This invention is a system allows Instant Messenger user to do zero cost startup business and help improve ad recommendation engine in a crowd sourcing model. It is a kind of mesh economy.

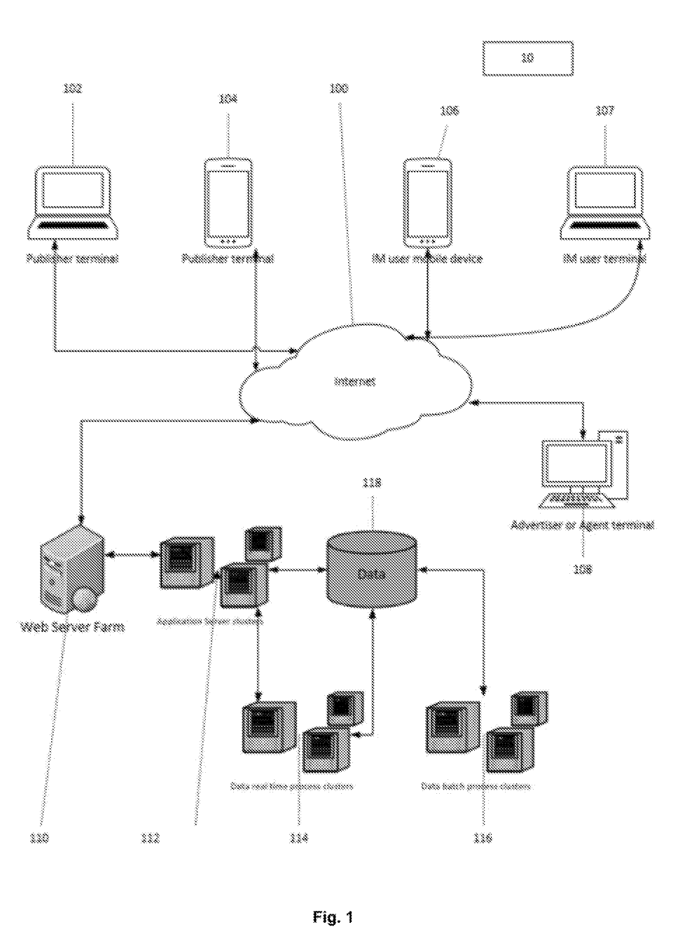

FIG. 1 is a block diagram illustrating one example of a system for advertising into Instant Messenger chatting context 10. The system for advertising into Instant Messenger chatting context 10 includes, but is not limited to, devices 102, 104, 106, 108 (only 4 of which are illustrated). The devices include, but not limited to, non-mobile computers, wireless devices, laptop computers, mobile phones, personal information devices, personal digital/data assistants (PDA), hand-held devices etc. However, the present invention is not limited to these target electronic devices and more, fewer or others types of target electronic devices can also be used. The target devices 102, 104, 106, 108 function as client devices in some instances and server devices in other instances. These devices 102, 104 can be used by publishers to capture live chat content.

Web server devices 110 (only one of which are illustrated) is a Web server farm that includes one or more web server that serves communication coming from the Internet 100. Application server devices 112 process data coming from the front end web servers and send requests to real time data process dusters 114 and data storage devices 118_{—} Batch process duster 116 fetch data from data storage devices 118 and process the data and store result back into data storage devices 118. Data storage devices 118 includes, but is not limited to, Relational Database Management System, NoSQL database, NewSQL database, and other Big Data storage platform.

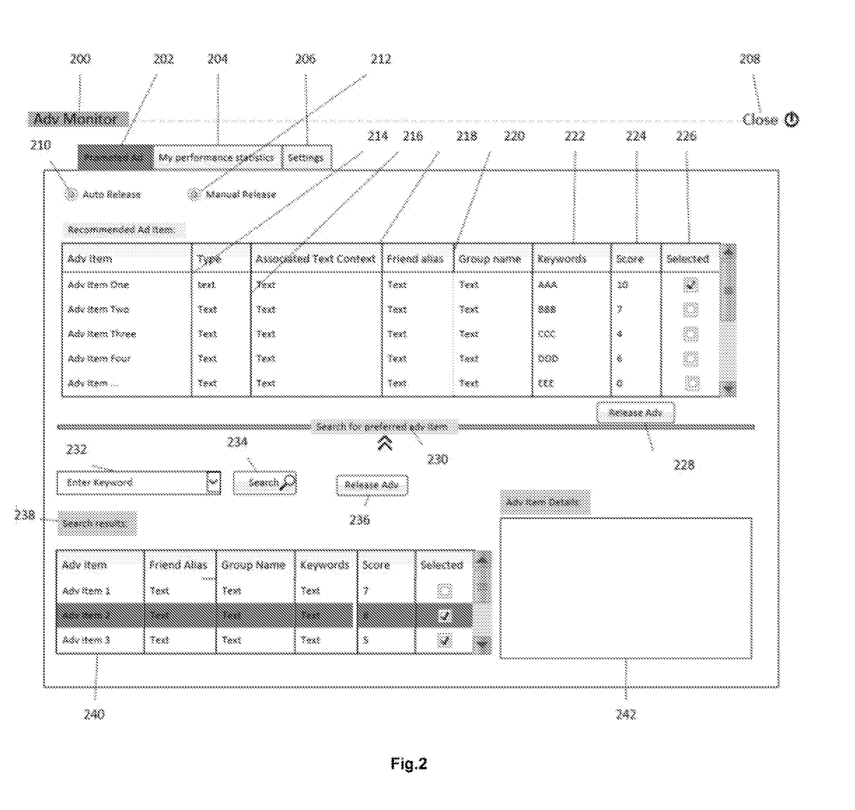

FIG. 2 depicts one example of a graphical user interface running on a computing device capable of running an instant messaging client and/or web browser, according to one embodiment The whole GUI 200 holds several tabs including, but not limited to, Promoted Ad 202, publisher performance statistics 204, and Settings 206, etc. Promoted Ad 202 tab includes, but not limited to, components 210, 212, 214, 216, 218, 220, 222, 224, 226, 228, 230, 232, 234, 236, 238, 240, and 242, etc.

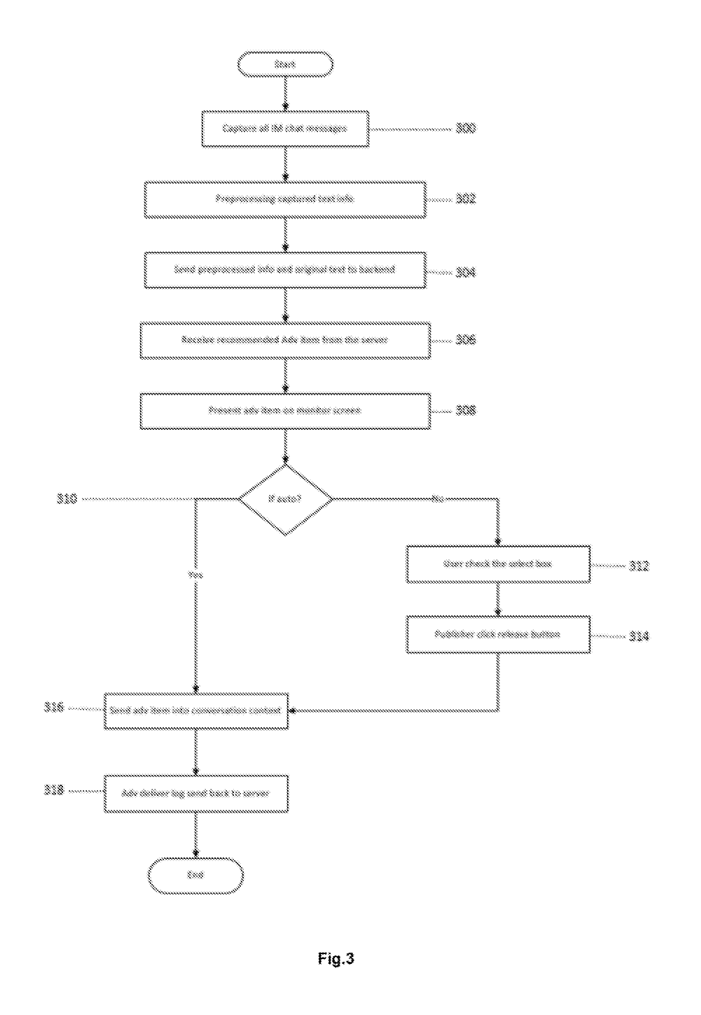

FIG. 3 is a block diagram illustrating one example of overall flow chart about how the chat context is processed and ad is recommended. An advertiser may, via a user terminal 108, register with the website 110 to get permissions to create and set up ad campaigns. Then, an ad is selected based on real time data process 114, which contains an ad recommendation engine running on. Real time data process 114, make recommendation based on the data send from publisher's terminals including, but not limited to 102, 104. The precisely recommended ad will be sent and displayed on users terminals include, but not limited to, 106, 107.

At 300, the client application captures the conversation in real time. The real time conversation content can be captured in different ways. For instance, if the device supports a desktop web browser, a browser add-on can be developed to capture all real time internet traffic including instant messenger's real time conversation content. For another instance, it the device is a smart phone, a background service can be developed to listen on any user interface status changing info including any new message arrived. Once the real time conversation content is captured at 300. The info can be processed in the next step.

At 302, the conversation content may or may not be preprocessed before the into will be sent to the server for getting recommended ad items. For instance, the Preprocess includes, but not limited to, sentiment lexicon generation. At 304, the processed info is sent to backend system over the Internet 100 in a secure way. At 306, the client application received recommended ad items from the server side. At 308, the client application presents ad items on the GUI 200.

At 310, if the publisher setting choose Auto Release 210, the recommended ad items' info will be presented in columns including, but not limited to, 214, 216, 218, 220, 222, 224, and 226, etc. At 222, publishers can modify the keywords associated with this ad item. At 224, publishers can modify the score number, which determine the precise of the recommendation. All modification is sent back to server side for updating recommendation engine model. These features are important as they allow publishers to participate on improving recommendation engine's machine learning model in a crowdsourcing way. At 316, the ad items are released into conversation context.

At 310 if the publisher choose Manual Release 212, the publisher get opportunity review the recommended ad item. Also, the publisher can modify values at 222 and 224. All modification is sent back to server side for updating recommendation engine model too. At 312, publishers select check boxes 226. At 314, publishers click release button 228.

At 316, the client application send the recommended and/or selected ad items into conversation context. At 318, the log about the ad items releasing is sent back to the server side.

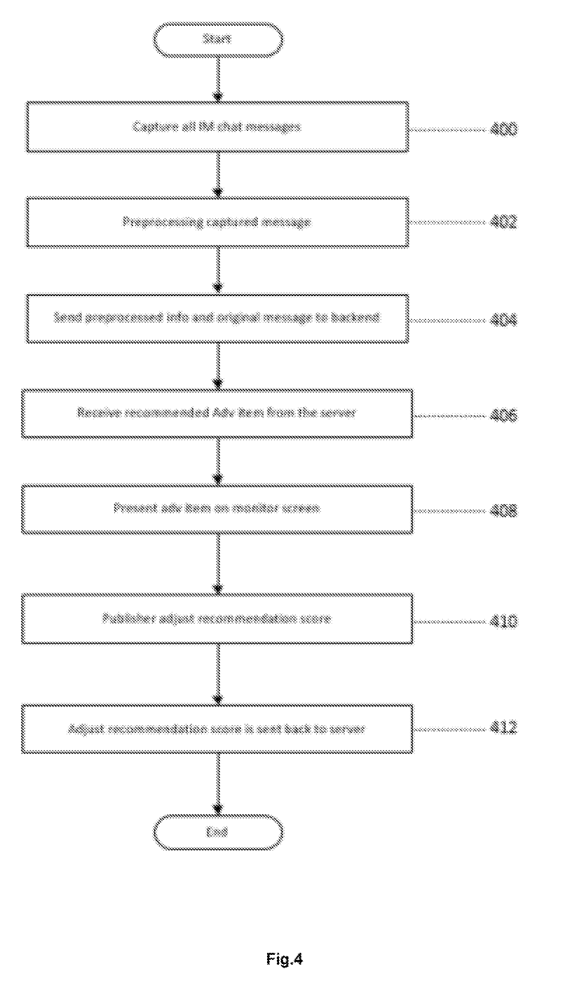

FIG. 4 is a block diagram illustrating one example of how an ad is released into chat context and how a publisher can contribute to improve backend recommend engine. At 400, client application captures all chatting message. At 402, the captured message is preprocessed. At 404. the preprocessed messages are sent back to the backend for further processing. At 406, client application received the recommended ad items from the server.

At 408, the client application presents ad item on GUI 200. At 410, publisher can adjust the associated key words at 222 and the recommendation precise score at 224. At 412, adjust keywords and/score are sent back to the server side for updating recommendation engine's machine learning model. In this way, this indentation applied crowd sourcing model into helping improve recommendation engine to get precise target ad in a more and more precise way. These features are important in this invention, For a machine learning training process, one of the difficult part is getting enough testing data to train the model. With these features, this invention allows publishers contribute to continually improve the recommendation engine's machine learning model in a crowd sourcing way.

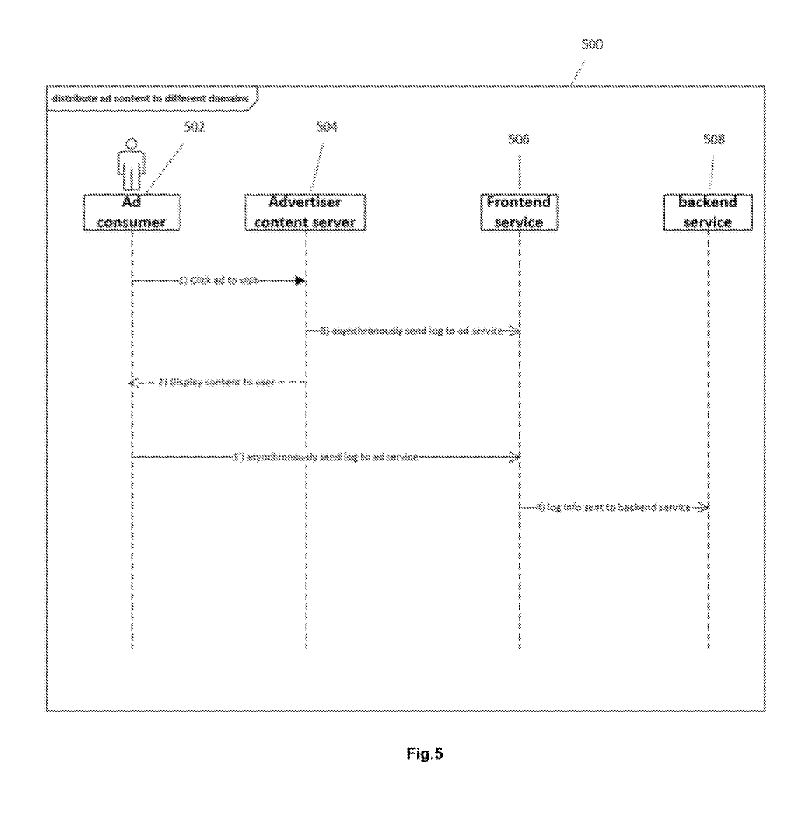

FIG. 5 is a sequence diagram illustrating one example of how the d content, can be distributed to any domain server 500. This is important as this invention need to be functional even without IM vendor's support.

At 602, a user click an ad item and the request is sent to any content server 604, which may highly possible the advertiser's own content server 504, At 504, it sends the ad item content back to the user. Meanwhile it asynchronously sends user request log to front-end service 606. Alternately, user's device at 602 can also send request log to front-end service 506 if it supports web browser with JavaScript enabled At 508, the backend service receives and processes logs sent from the frontend,

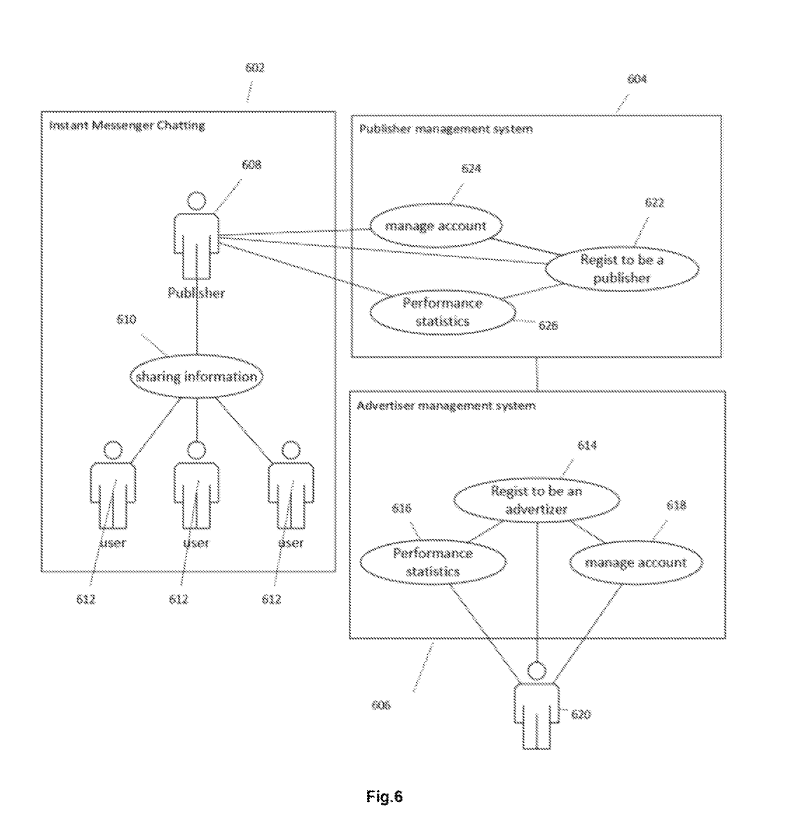

FIG. 6 is a use case diagram illustrating one example of how the business model included in this invention bring publishers, users, and advertisers together and do advertising in a shared economy way.

At 602 it represents a scenario which shows a group of people are chatting over the internet. Registered publishers and their online friends as users 612 are included. At 608, it represent publishers who registered on this invented system to be ad item publishers. These publishers then registered with any online chatting tool s 610 including, but not limited to, Whatsup™, Line™. and WeChat™ etc. This invention delivers ad items into the conversation context through publishers chatting system. As reward, the publisher can earn certain money from this invented system.

At 604, it represents a system that allows publishers to register 622 and manage their account 624. Also, publishers can do lots of other things including but not limited to, checking earning, ad click through rate etc.

At 606, it represents a system that allows advertisers or their agents to register 614 and manage advertisement campaigns 618. These ad campaigns will be delivered to online chatting users through ad recommender engine and publisher's online chatting account. At 616, advertisers can also do many other things including, but not limited to, checking each campaign's performance etc.

### REFERENCES

R. L. Zeff and B. Aronson, Advertising on the Internet, John Wiley & Sons. Inc., 1999.

A. E. Schlosser, S. Shavitt and A. Kanfer, “Survey of Internet users' attitudes toward Internet advertising,” Journal of interactive marketing, vol. 13, no. 3, pp. 34-54, 1999.

W.-H, Hsiao and T.-S. Chang, “Understanding consumers' continuance intention towards mobile advertising: a theoretical framework and empirical study,” Behaviour & Information Technology, vol, 33, no. 7, pp, 730-742. 2014.

wikipedia.org, “Sharing economy,” [Online]. Available: http://en.wikipedia.org/wiki/Sharing_economy.

www.wikipedia.org, “http://en.wikipedia.org/wiki/Crowdsourcing,” [Online].

www.wikipedia.org, “http://en.wikipedia org/wiki/Advertising_agency,” [Online].

www.wikipedia.org, “http://en.wikipedia.org/wiki/Sentiment_analysis,” [Online].

Overture, “System and method for influencing a position on a search result list generated by a computer network search engine”. U.S. Pat. No. 6,826,572 B2, Nov. 30, 2004.

Wikipedia.org, “http://en.wikipedia.org/wiki/Online_advertising,” [Online].

www.wikipedia.org, “http://en.wikipedia.org/wiki/Semantic_analysis,” [Online].

D. Angela Hausman, A. Maria Soares and J. Carlos Pinho, “Advertising in online social networks: the role of perceived enjoyment and social influence,” Journal of Research in Interactive Marketing, vol. 8, no. 3, pp. 245-263, 2014.

J. M.-S. Cheng, C. Blankson, E. S.-T. Wang and L. S.-L. Chen, “Consumer attitudes and interactive digital advertising,” International Journal of Advertising, vol. 28, no. 3, pp. 501-525, 2009.

“Advertisers Will Spend Nearly \$600 Billion Worldwide in 2015,” eMarketer.com 2014. [Online]. Available: http://www.emarketer.com/Article/Advertisers-Will-Spend-Nearly-600-Billion-Worldwide-201511011691.

D. Centola, “The spread of behavior in an online social network experiment,” science, vol. 329, no. 5996, pp. 1194-1197, 2010.

L. M. Solutions, “Targeted social media advertising solutions,” 2014. [Online]. Available:https://business.linkedin.com/marketing-solutions/social-media-advertising.

1. A method for advertising in an online community which has at least two users, the method comprising:
Receiving real time conversation content from Web browser;
Receiving real time conversation content from user's devices;
Preprocessing conversation in client side;
Ad recommendation engine precisely recommends ad items to client;
An ad recommendation engine which does not tracking user's behavior. Instead, it recommends ad items simply based on conversation among users;
Ad recommend engine has an incrementally updated machine learning model;
Publishers can adjust keywords associated with recommended ad item. The adjusted info is sent back to server side for updating database and recommendation model;
Publishers can adjust precise score associated with recommended ad item. The adjusted info is sent back to server side for updating database and recommendation model;
Publishers can choose if the recommended ad item can be automatically released or needs publisher to approve it;
Publishers help increasing precise target advertising in a crowd sourcing way;
A set of rules is defined for preventing duplicated ad items to be released into same conversation context in a short time interval;
A set of rules is defined for deciding which publisher can benefit from the ad item release if there are multiple publishers in a same conversation context.
A business model that allows publishers to register in the system and work as publisher without any cost.

2. The method according to claim 1 further comprising:
Capturing user chatting content in real time on terminals including, but not limited to user devices, web browsers, etc. Without supports from IM venders, it is difficult to get conversation content in real time. Especially, it is true for IM app running on mobile devices like smart phone. However, this invention solved this in several ways. Today, almost all kind of instant messenger running on smart phone have their Web app clone and/or desktop application done. So, developing a browser add-on that can capture all browser's Internet traffic is a feasible way to do this. With the add-on, real time conversation content can be captured, processed. Meanwhile, the ad item can be sent into real time conversation context.

3. The method according to claim 1, further comprising:
Preprocessing conversation content before it is sent to the server side for further processing. Preprocessing info on the client can significantly reduce the burden of backend servers. With this kind design, this invention successfully distributes computing task to each publisher's terminal.

4. The method according to claim 1, further comprising:
An ad recommendation engine applies machine learning technologies including, but not limited to, sentiment analysis, etc. Traditionally ad recommendation engine recommends ad item based on user's behavior, which are all users history data. In this invention, sentiment analysis is ad opted to recommend ad item. This invention achieves more precise ad targeting result because it uses real time data to analyze user's interested products, tastes etc. and sends user back the recommended ad item in real time. Therefore, the ad is more effective because users are still in the greatest interests and mood to check out the ad item.

5. The method according to claim 1, further comprising:
Opinion analysis based advertise deliver instead of just keywords matching. [7]Different from other recommendation engine that keywords match only, this invention applies sentiment analysis and opinion analysis as advanced options.

6. The method according to claim 1, further comprising:
Publisher can be allowed to modify key words associated with recommended ad items. The modified info is sent back to server side for updating database and machine learning, model in either real time model or batch process model. This is important as this feature allows publishers to contribute on improving machine learning model in a crowd sourcing way.

7. The method according to claim 1, further comprising:
Publisher can be allowed to modify precise score, which is used to judge how precise recommend ad items are, and the modified into is sent back to the server side for updating database and machine learning model in either real time model or batch processing model.

8. The method according to claim 1, further comprising:
Business model that allows publisher to start their ad releasing business with almost no cost. What the publisher needs are just one terminal that allow them to use IM clients. Once publishers registered on this invention's system, this invention' can select suitable ad items based on captured real time conversation content and inject ad into tarn conversation context through publishers' online chatting account as if the ad items are shared by publishers. This Mesh economy type business model enable publishers to start their ad publishing business with extremely low cost. Furthermore, since publishers release ad item in a way of sharing info. It could be very effective.

9. The method according to claim 1, further comprising:
The process that allow publishers to help on improving ad recommendation engine's machine learning model. This is a perfect way to applies crowd sourcing methodology into continuously improving ad recommendation engine's machine learning model.

10. The method according to claim 1, further comprising:
An ad recommendation engine whose machine learning models is incrementally updated in real time process and/or batch process. Along with the usage of the system. more and more data is inputted. The machine learning model should be updated accordingly in both real time and batch processing. This invention implements the method with witch the machine learning model for ad recommendation is incrementally updated with the feedback data from, for examples, claims 6, 7, and 8 etc.

11. The method according to claim 1, further comprising:
Defining rules for preventing duplicated ad items to be released into same conversation context in a certain time interval; for examples, but limited to, second same ad could be released after either certain time interval or certain pages scroll over on a smart devices.

12. The method according to claim 1, further comprising:
Defining rules deciding which publisher can benefit from the ad item release if there are multiple publishers in a same conversation context. Client software is capable detected other publishers released message and do necessary process based on the defined rules as described in claim 11.

13. The method according to claim 1, further comprising:
The process that hosts ad item content among distributed servers having different domain names. For examples, advertisers can host their own ad content on their own web servers. The benefit of this is avoiding conflict with IM vendors' interests.

14. A system comprising:
One or more devices coupled to a network; and
One or more server computers coupled to a network; and
One or more databases coupled to one or more server computers;
Wherein one or more servers/computers are for:
In response to capture real time conversation context and preprocessing context;
Facilitating display of a GUI for showing info to publishers;
Hosting Web services for publisher registered and managing their account;
Hosting Web service for advertiser to register and manage their ad campaigns;
Hosting application servers for processing business logics;
Hosting real time Big Data processing system;
Hosting data batch processing system;
Hosting data storage system.

15. The method according to claim 14, further comprising:
A device executed to:
Capturing user's conversation;
Preprocessing captured conversation context;
Formatting content and send it back to the server.

16. The method according to claim 14, further comprising:
A client GUI module to:
Representing all recommended ad items as determined in FIG. 2;
Representing a UI for publisher to check his performance, for example how much he has own in one day, one week, one month etc.;
Representing a UI for publisher to change settings.

17. The method according to claim 14, further comprising:
An ad recommendation engine subsystem to:
Based on received user's conversation content, it recon ends ad items for delivering to publishers;
Based on received publisher's adjusted precise score, it adjusts recommendation machine learning model in real time;
Based on received publisher's adjusted key words associated with certain ad items, it adjusts recommendation machine learning model in real time.

18. The method according to claim 14, further comprising:
A data batch processing module to:
Based on system settings and received feedback data, it optimizing recommendation engine's machine learning model.

19. The method according to claim 14, further comprising:
An application system to:
Allow advertisers to create and manage their campaigns, Especially, different from other online ad solutions, that mainly face to either in-house agent or advertiser. This invention enable those small local ad agents to use this system to input and manager their local customers ad campaign.

20. An application system to:
Allow ad content distributed on different content server having different domain name It happened before that instant messenger vendor tried to block another third party's online service. This design about distributing ad content on different ad content server is a way to avoid that kind of blocking as instant messenger vendor should not block all advertisers' own domain names. When ad content are host on different domain names, this invention can still track the consume of the ad as some cross domain scripting is used in the system as described on FIG. 5. FIG. 5 is a sequence diagram illustrating one example of how the ad content can be distributed to any domain server.
